(19) United States
(12) Patent Application Publication
(10) Pub. No.: US 2014/0111060 A1
(43) Pub. Date: Apr. 24, 2014

(54) MICRO-ELECTRO-MECHANICAL GENERATOR AND ELECTRICAL DEVICE USING THE SAME

(71) Applicant: Panasonic Corporation, Osaka (JP)

(72) Inventor: Yasuyuki Naito, Osaka (JP)

(73) Assignee: Panasonic Corporation, Osaka (JP)

(21) Appl. No.: 13/980,966

(22) PCT Filed: Nov. 19, 2012
(86) PCT No.: PCT/JP2012/007419

§ 371 Date: Jul. 22, 2013

(30) Foreign Application Priority Data
Dec. 12, 2011 (JP) 2011-270893

(51) Int. Cl. H02N 1/08

(52) U.S. Cl. CPC H02N 1/08
USPC 310/300

(57) ABSTRACT

Provided is a micro-electro-mechanical generator including: a first substrate configured to hold an electric charge on a surface of the substrate, and to have an electret film continuously provided on the surface; a second substrate having a collecting electrode provided on a surface facing the electret film; and a movable substrate having conductive property, disposed between the first and the second substrates, and supported movably along a predetermined direction with respect to the first and the second substrates. The movable substrate includes an opening penetrating through the movable substrate from a side of the first substrate to a side of the second substrate and allowing an electric field emitted from the electret film to pass through. The movement of the movable substrate causes or stops to cause the electric field to be emitted to the collecting electrode through the opening, and power is generated by the electric charge being excited in and discharged from the collecting electrode depending on whether or not the electric field is caused to be emitted.

### BACKGROUND OF THE INVENTION

1. Field of the Invention

The present invention relates to micro-electro-mechanical generators and electrical devices using such a generator. In particular, the present invention relates to a micro-electro-mechanical generator as an electrostatic vibrational generator for generating power depending on vibration in the environment, and to an electrical device using a generator of this type.

2. Description of Related Art

Micro electro mechanical systems (MEMS) are applied to various industrial fields such as wireless technology, optical technology, acceleration sensors, biotech, and power generation. Among these, in the field of power generation, energy harvesters that collect and utilize energy such as light, heat, and vibration scattered in the environment have been developed as devices based on the MEMS technology. By applying such an energy harvester to a power source in a low-power wireless equipment, for example, it is possible to achieve a small electrical device for a wireless sensor network and the like that does not need a power cable or a battery. An energy harvester may be downsized by an application of the MEMS technology to the energy harvester.

In an environment where an amount of light and heat generation is small, a vibrational generator that generates power using vibration of members constituting a device by a force applied from an external environment is effective. Examples of types of such a vibrational generator include a piezoelectric type, an electromagnetic type, and an electrostatic type. An electrostatic vibrational generator is advantageous in that this type of generator does not require a piezoelectric material or a magnetic material, and can be manufactured through a simple manufacturing method.

The electrostatic vibrational generator is provided with an electric-charged electret and an electrode opposite with the electret, and is configured such that an area where the electret and the electrode face each other changes when a weight is vibrated due to a force applied from the external environment. Specifically, the electrostatic vibrational generator is an energy harvester that realizes power generation based on power feed to and discharge from the electrode, since an electrostatic capacitance repeatedly varies in a range between a maximum value and a minimum value depending on a change in the electrostatic capacitance along with the change in the area where the electret and the electrode face each other. Various electrostatic vibrational generators have been proposed in the past.

FIG. 17 is a sectional view of a vibrational generator described in International Patent Publication WO 2008/026407. Referring to FIG. 17, an electret film 91 is provided on a surface of a static electrode 90 made of silicon. Further, movable electrodes 93 are provided on a surface of a movable substrate 92 facing the static electrode 90 so as to face the electret film 91. Moreover, the electret film 91 is patterned in an interdigitated manner.

FIG. 18 is a sectional view of a different vibrational generator described in WO 2008/026407. Referring to FIG. 18, an electret film 5 made of an organic material such as PTFE or made of a silicon dioxide film is provided on a surface of a static electrode 4 made of silicon. Further, a conductive layer 6 is provided on a surface of the electret film 5.

### SUMMARY OF THE INVENTION

In order to increase an amount of power generation of the electrostatic vibrational generator, it is necessary to increase an amount of power feeding in maximum capacity, or increase a capacitance change ratio between the maximum value and the minimum value of the electrostatic capacitance. These are achieved by increasing a potential of the electret, and/or decreasing a gap between the electrode and the electret.

In the configuration illustrated in FIG. 17, it is necessary to perform micro-patterning to the electret in an interdigitated manner. However, it has been found that an electric charge that is electric-charged on the electret may easily escape from the electret that has been patterned, and thus there is a problem in reliability that the potential of the electret decreases in the long run.

On the other hand, in the configuration illustrated in FIG. 18, since the electret is not pattered in an interdigitated manner, transfer of the electric charge from the electret may be suppressed. However, it has also been found that the electric charge transfers from the electret to the conductive layer since the conductive layer is directly provided on the electret, and thus there is a problem that the potential of the electret decreases.

Further, G. Altena et al. describe a configuration in which a patterned electric field is generated by providing a vibrational body (conducting body) at a position facing an electret that is not patterned, and by exciting electric charge in the vibrational body (conducting body) having an interdigitated pattern (G. Altena et al. “DESIGN, MODELING, FABRICATION AND CHARACTERIZATION OF AN ELECTRET-BASED MEMS ELECTROSTATIC ENERGY HARVESTER” Solid-State Sensors, Actuators and Microsystems Conference (TRANSDUCERS), 2011 16th International, Jun. 5, 2011 (P739-P742)). However, it has been found that there is a problem that efficiency of power generation may deteriorate, since the electric charge excited in the vibrational body (conducting body) is used, instead of directly using the electric charge of the electret.

An object of the present invention is to provide, as a micro-electro-mechanical generator, an electrostatic vibrational generator whose amount of power generation is increased and reliability is improved.

A micro-electro-mechanical generator according to the present invention is provided with: a first substrate configured to hold an electric charge on a surface of the substrate, and to have an electret film continuously provided on the surface;

a second substrate having a collecting electrode provided on a surface facing the electret film; and

a movable substrate having conductive property, disposed between the first substrate and the second substrate, and supported movably along a predetermined direction with respect to the first substrate and the second substrate,

wherein the movable substrate includes an opening penetrating through the movable substrate from a side of the first substrate to a side of the second substrate and allowing an electric field emitted from the electret film to pass through, and

the movement of the movable substrate either causes or stops to cause the electric field to be emitted to the collecting electrode through the opening, and power is generated by the electric charge being excited in and discharged from the collecting electrode depending on whether or not the electric field is caused to be emitted.

According to the micro-electro-mechanical generator of the present invention, it is possible to reduce a potential drop of the electret over time since transfer of the electric charge from the electret may be suppressed. Therefore, it is possible to achieve an increase of an amount of power generation and an improvement of reliability at the same time. Additionally, it is possible to achieve the electrical device using this micro-electro-mechanical generator as a power source.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a cross-sectional view illustrating a configuration of a micro-electro-mechanical generator according to a first embodiment;

FIG. 2 is a cross-sectional view illustrating the configuration of the micro-electro-mechanical generator according to the first embodiment;

FIG. 3 is a plan view illustrating an arrangement of a first electrode in the micro-electro-mechanical generator according to the first embodiment;

FIG. 4 is a plan view illustrating a configuration of a movable substrate in the micro-electro-mechanical generator according to the first embodiment;

FIG. 5 is a cross-sectional view illustrating a configuration of a micro-electro-mechanical generator according to a first modified example of the first embodiment;

FIG. 6 is a cross-sectional view illustrating the configuration of the micro-electro-mechanical generator according to the first modified example of the first embodiment;

FIG. 7 is a cross-sectional view illustrating a configuration of a micro-electro-mechanical generator according to a second modified example of the first embodiment;

FIG. 8 is a cross-sectional view illustrating the configuration of the micro-electro-mechanical generator according to the second modified example of the first embodiment;

FIG. 9 is a cross-sectional view illustrating the configuration of the micro-electro-mechanical generator according to the second modified example of the first embodiment;

FIG. 10A is a cross-sectional view illustrating a method of manufacturing the micro-electro-mechanical generator according to the first embodiment;

FIG. 10B is a cross-sectional view illustrating the method of manufacturing the micro-electro-mechanical generator according to the first embodiment;

FIG. 11A is a cross-sectional view illustrating the method of manufacturing the micro-electro-mechanical generator according to the first embodiment;

FIG. 11B is a cross-sectional view illustrating the method of manufacturing the micro-electro-mechanical generator according to the first embodiment;

FIG. 12A is a cross-sectional view illustrating the method of manufacturing the micro-electro-mechanical generator according to the first embodiment;

FIG. 12B is a cross-sectional view illustrating the method of manufacturing the micro-electro-mechanical generator according to the first embodiment;

FIG. 13 is a cross-sectional view illustrating the method of manufacturing the micro-electro-mechanical generator according to the first embodiment;

FIG. 14 is a circuit diagram illustrating the configuration of the micro-electro-mechanical generator according to the first embodiment;

FIG. 15 is a cross-sectional view illustrating a configuration of a micro-electro-mechanical generator according to a second embodiment;

FIG. 16 is a cross-sectional view illustrating the configuration of the micro-electro-mechanical generator according to the second embodiment;

FIG. 17 is a cross-sectional view illustrating a configuration of a conventional micro-electro-mechanical generator; and

FIG. 18 is a cross-sectional view illustrating a configuration of a conventional micro-electro-mechanical generator.

### DETAILED DESCRIPTION OF EMBODIMENTS

A micro-electro-mechanical generator according to a first aspect is provided with: a first substrate configured to hold an electric charge on a surface of the substrate, and to have an electret film continuously provided on the surface;

a second substrate having a collecting electrode provided on a surface facing the electret film; and

a movable substrate having conductive property, disposed between the first substrate and the second substrate, and supported movably along a predetermined direction with respect to the first substrate and the second substrate,

wherein the movable substrate includes an opening penetrating through the movable substrate from a side of the first substrate to a side of the second substrate and allowing an electric field emitted from the electret film to pass through, and

the movement of the movable substrate either causes or stops to cause the electric field to be emitted to the collecting electrode through the opening, and power is generated by the electric charge being excited in and discharged from the collecting electrode depending on whether or not the electric field is caused to be emitted.

According to a second aspect, the micro-electro-mechanical generator of the first aspect may be configured such that the movable substrate is supported vibratably along the predetermined direction.

According to a third aspect, the micro-electro-mechanical generator of the first or the second aspect may be configured such that the movable substrate is supported movably with respect to the first substrate and the second substrate so as to change an overlapping area between the electret film and the collecting electrode through the opening in the movable substrate in a process of the movement.

According to a fourth aspect, the micro-electro-mechanical generator of one of the first to the third aspect may be configured such that the opening in the movable substrate is patterned into a plurality of the openings.

According to a fifth aspect, the micro-electro-mechanical generator of one of the first to the fourth aspect may be configured such that the collecting electrode of the second substrate is patterned into a plurality of the collecting electrodes.

According to a sixth aspect, the micro-electro-mechanical generator of one of the first to the fifth aspect may be configured such that the collecting electrode is patterned into a plurality of the collecting electrodes having a first cycle along the predetermined direction,

the opening is patterned into a plurality of the openings having a second cycle along the predetermined direction, and

the first cycle and the second cycle are in a relation of integral multiple with each other, such that the collecting electrode and the opening are patterned in cycles synchronizable with each other.

According to a seventh aspect, the micro-electro-mechanical generator of one of the first to the sixth aspect may be configured such that the collecting electrode is patterned into a plurality of the collecting electrodes having a cyclic pattern along the predetermined direction, and

the opening is patterned into a plurality of the openings having a cyclic pattern identical to the cyclic pattern of the collecting electrodes along the predetermined direction.

According to an eighth aspect, the micro-electro-mechanical generator of one of the first to the seventh aspect may be configured such that the movable substrate is grounded.

According to a ninth aspect, the micro-electro-mechanical generator of one of the first to the eighth aspect may further include a guard electrode that is grounded, and may be configured such that the collecting electrode is patterned into a plurality of the collecting electrodes, and the guard electrode is provided between each pair of the collecting electrodes.

An electrical device according to a tenth aspect may include the micro-electro-mechanical generator according to one of the first to the ninth aspect as a power source.

The micro-electro-mechanical generator according to preferred embodiments will now be described with reference to the drawings. Throughout the drawings, like components are denoted by like reference numerals. It should be appreciated that the present invention is not limited to the embodiments described hereinafter.

### First Embodiment

Configuration of Micro-Electro-Mechanical Generator

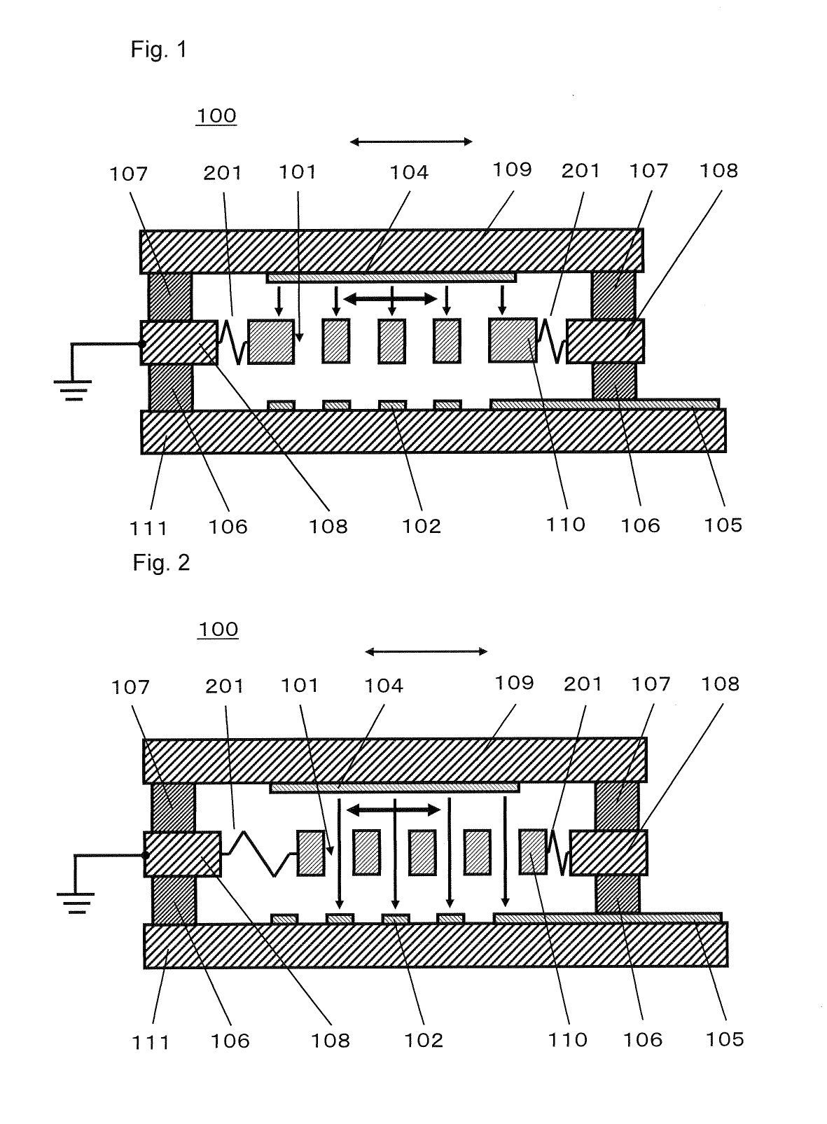

FIG. 1 and FIG. 2 are cross-sectional views illustrating a configuration of a micro-electro-mechanical generator 100 according to the first embodiment. The micro-electro-mechanical generator 100 illustrated in FIG. 1 and FIG. 2 is provided with a lower substrate 111 as a first substrate, an upper substrate 109 as a second substrate, a movable substrate 110, springs 201 as an elastic structure, and a static structure 108. Referring to FIG. 1, an upper surface of the lower substrate 111 and a lower surface of the upper substrate 109 face each other. Accordingly, in the power generator 100, the upper surface of the lower substrate 111 and the lower surface of the upper substrate 109 respectively correspond to a first substrate surface and a second substrate surface.

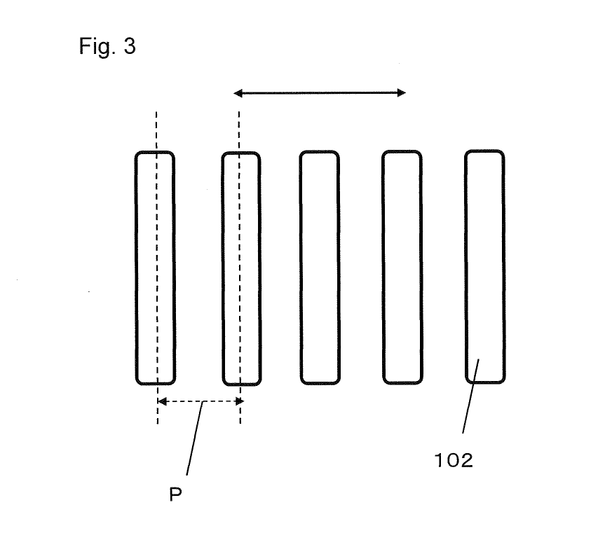

FIG. 3 is a plan view illustrating an arrangement of a first electrode 102. On the first substrate surface (upper surface) of the lower substrate 111, there is provided a plurality of the first electrodes 102 patterned as illustrated in FIG. 3. Further, a pad 105 for wiring outside from the first electrodes 102 is provided on the first substrate surface. On the second substrate surface (lower surface) of the upper substrate 109, an electret 104 configured to generate an electric field and facing the movable substrate 110 is provided. The electret 104 is electric-charged so as to hold an electric charge semipermanently. The static structure 108, the movable substrate 110, and the spring 201 are usually formed by processing a single substrate. Therefore, these members are also collectively called as “the intermediate substrate 108 to which the movable substrate (or a movable unit or a weight) 110 is connected via the elastic structures 201” or “the intermediate substrate 108 having the weight 110 movable by means of the elastic structures 201”.

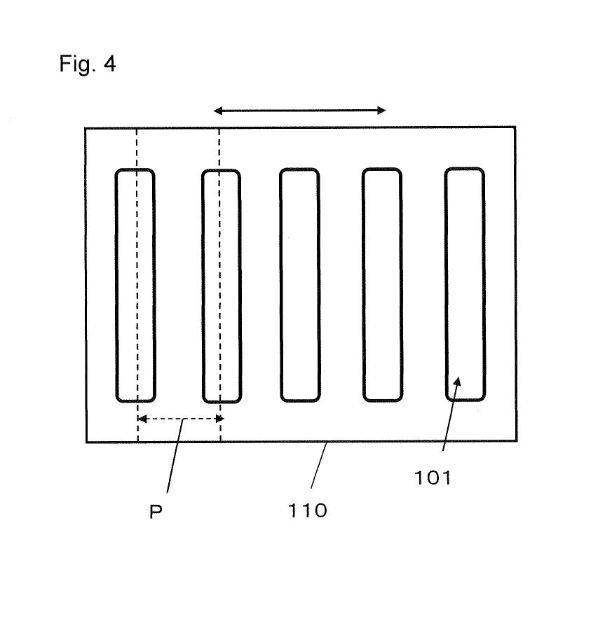

FIG. 4 is a plan view illustrating a configuration of the movable substrate 110. The movable substrate 110 follows external vibration, and vibrates (that is, reciprocated) at least along one axial direction (the direction indicated by a double-headed arrow in the figure) parallel to the surfaces facing the upper substrate 109 and the lower substrate 111 (thus, the first substrate surface and the second substrate surface). In order to make the movable substrate 110 vibrate following the external vibration, the movable substrate 110 is required to have a certain weight. Accordingly, it is desirable that a thickness of the movable substrate 110 be within a range from 100 μm to 1 mm. The movable substrate 110 facing the first substrate surface includes a plurality of substrate through holes 101 (hereinafter referred to as “slits 101”) provided by having the movable substrate 110 be penetrated in a pattern similar to the plurality of first electrodes 102. A width of the slits 101 may be, but not limited to, 100 μm, and may also be within a range from 10 μm to 1 mm.

In the illustrated embodiment, the plurality of first electrodes 102 are disposed in parallel with each other at regular intervals. Further, the first electrodes 102 are arranged along a direction parallel to the direction in which the movable substrate 110 moves. Specifically, the first electrodes 102 are arranged as illustrated in FIG. 3 when viewed perpendicularly to the first substrate surface. Here, the intervals between the plurality of first electrodes 102 correspond to a distance P in FIG. 3, which is a distance between central lines of adjacent two of the first electrodes 102, each line passing a center of the corresponding electrode in an across-the-width direction (the direction parallel to the direction in which the movable substrate 110 moves). Further, the slits 101 are arranged in the same pattern as the first electrodes 102.

The lower substrate 111 and the static structure 108 are joined by lower joint portions 106 such that a predetermined gap is defined between the first electrodes 102 and the movable substrate 110. Similarly, the upper substrate 109 and the static structure 108 are joined by upper joint portions 107 such that a predetermined gap is defined between the electret 104 and the movable substrate 110.

In the micro-electro-mechanical generator 100 thus configured, the electret 104 itself is not patterned and the first electrodes 102 facing the electret 104 are patterned. Further, the movable substrate 110 having the slits 101 provided between the electret 104 and the patterned first electrodes 102, the movable substrate 110 is provided as being vibratably supported between the electret 104 and the first electrodes 102. According to such a configuration, when the movable substrate 110 is positioned as illustrated in FIG. 1, the electric field generated from the electret 104 may be blocked by being pulled into the movable substrate 110 according to positions of the slits 101. Alternatively, when the movable substrate 110 is moved as illustrated in FIG. 2, a part of the electric field generated from the electret 104 may pass through the slits 101 to the first electrodes 102 according to the positions of the slits 101. In other words, an electric field may be generated corresponding to the pattern of the slits 101 by the movement of the movable substrate 110. According to the micro-electro-mechanical generator 100 of the first embodiment, since micro-patterning to the electret 104 is not necessary, it is possible to achieve the micro-electro-mechanical generator 100 having high power generation efficiency and having the electret 104 that is highly retentive of an electric charge and highly reliable.

The movable substrate 110 may be configured by a conducting body such as silicon, in order to pull the electric field generated from the electret 104 into the movable substrate 110. Further, a conducting body made of aluminum and the like may be provided on the movable substrate 110.

The movable substrate 110 may also be configured such that its potential is determined by grounding, for example.

In the micro-electro-mechanical generator 100 illustrated in FIG. 1, the first electrodes 102 and the slits 101 are arranged as being completely misaligned (shifted) when viewed perpendicularly to the first substrate surface. Specifically, in the illustrated embodiment, the first electrodes 102 and the slits 101 are not collinear in a direction perpendicular to the first substrate surface. In this case, the electric field generated from the electret 104 toward the first electrodes 102 is blocked by the movable substrate 110. Further, in this case, an overlapping area where the electret 104 overlaps with the first electrodes 102 through the slits 101 is minimized (the overlapping area is zero in the above example).

On the other hand, in the state as illustrated in FIG. 2, the movable substrate 110 moves, and the first electrodes 102 and the slits 101 are arranged so as to be aligned with each other when viewed perpendicularly to the first substrate surface. Specifically, in the embodiment illustrated in FIG. 2, the first electrodes 102 and the slits 101 are collinear in the direction perpendicular to the first substrate surface, and overlapping with each other. In this case, the overlapping area between the electret 104 and the first electrodes 102 through the slits 101 is maximized, and the electric field generated from the electret 104 toward the first electrodes 102 passes through the slits 101 to reach the first electrodes 102.

Specifically, according to the micro-electro-mechanical generator 100, the overlapping area between the electret 104 and the first electrodes 102 through the slits 101 may change by moving the movable substrate 110. Accordingly, the electric field generated from the electret 104 may be controlled so as to be blocked by the movable substrate 110 (FIG. 1) or to pass through the slits 101 to reach the first electrodes 102 (FIG. 2).

In the illustrated embodiment, a width of the first electrodes 102 and the width of the slits 101 (dimensions parallel to the direction in which the movable substrate 110 moves) are the same. When the width of the first electrodes 102 and the width of the slits 101 are different, for example, the alignment between the first electrodes 102 and the slits 101 when viewed perpendicularly to the first substrate surface indicates that the central lines of the first electrodes 102 and the slits 101 in the across-the-width direction match.

According to this configuration, the electric field between the electret 104 and the first electrode 102 may be switched between presence and non-presence depending on either the electric field generated from the electret 104 reaches to the first electrode 102 or not, while the movable substrate 110 vibrates. More specifically, when the overlapping area between the electret 104 and the first electrodes 102 through the slits 101 is maximum, the electric field applied to the first electrodes 102 is maximized, and an electric charge may be excited in the first electrodes 102. On the other hand, when the overlapping area between the electret 104 and the first electrodes 102 through the slits 101 is minimum, the electric field applied to the first electrodes 102 is minimized, and an electric charge excited in the first electrodes 102 may be released. Accordingly, alternating current can be generated in the pad 105 by repeating power feed to and discharge from the first electrodes 102 along with the vibration of the movable substrate 110.

According to the micro-electro-mechanical generator of the first embodiment, an escape of the electric charge from the electret 104 can be suppressed, since micro-patterning to the electret 104 is not required. Further, since a conductive layer is not directly provided on the electret 104, and since there is a gap between the electret 104 and the movable substrate 110, the transfer of the electric charge from the electret 104 can be suppressed.

As described above, according to the micro-electro-mechanical generator 100 of the first embodiment, an increase of an amount of power generation and an improvement of reliability in the micro-electro-mechanical generator may achieve at the same time, and thus various electrical devices may be provided by incorporating this generator as a power source.

### FIRST MODIFIED EXAMPLE

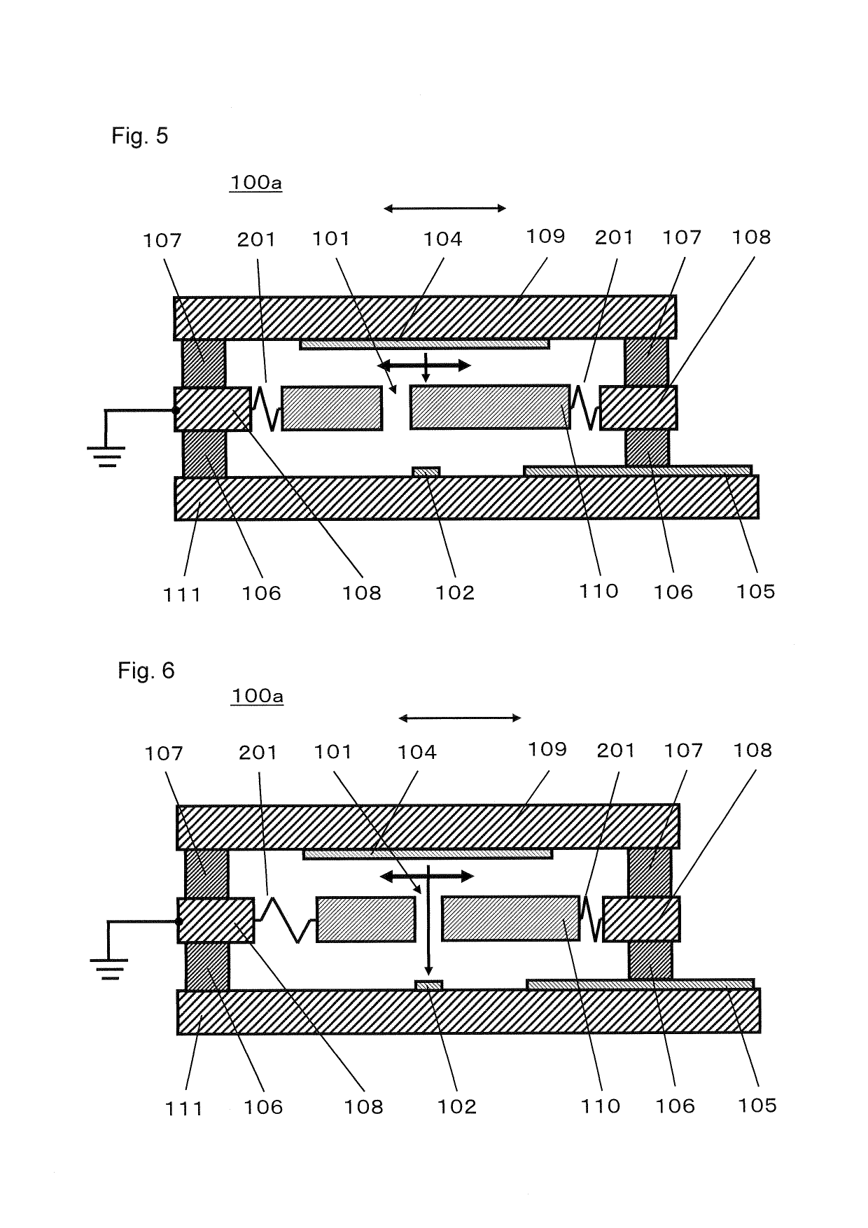

FIG. 5 and FIG. 6 are cross-sectional views illustrating a configuration of a micro-electro-mechanical generator 100a according to a first modified example of the first embodiment. The micro-electro-mechanical generator 100a according to the first modified example is different from the micro-electro-mechanical generator 100 according to the first embodiment illustrated in FIG. 1 and FIG. 2 in that the first electrode 102 is provided only one and not patterned, and in that a single slit 101 is provided in the movable substrate 110.

According to the micro-electro-mechanical generator 100a of the first modified example, when the movable substrate 110 is positioned as illustrated in FIG. 5, the electric field generated from the electret 104 may be blocked by being pulled into the movable substrate 110 according to a position of the slit 101. Alternatively, when the movable substrate 110 is moved as illustrated in FIG. 6, a part of the electric field generated from the electret 104 may pass through the slit 101 to the first electrode 102 according to the position of the slit 101. In other words, an electric field corresponding to the pattern of the slit 101 may be generated by the movement of the movable substrate 110.

### SECOND MODIFIED EXAMPLE

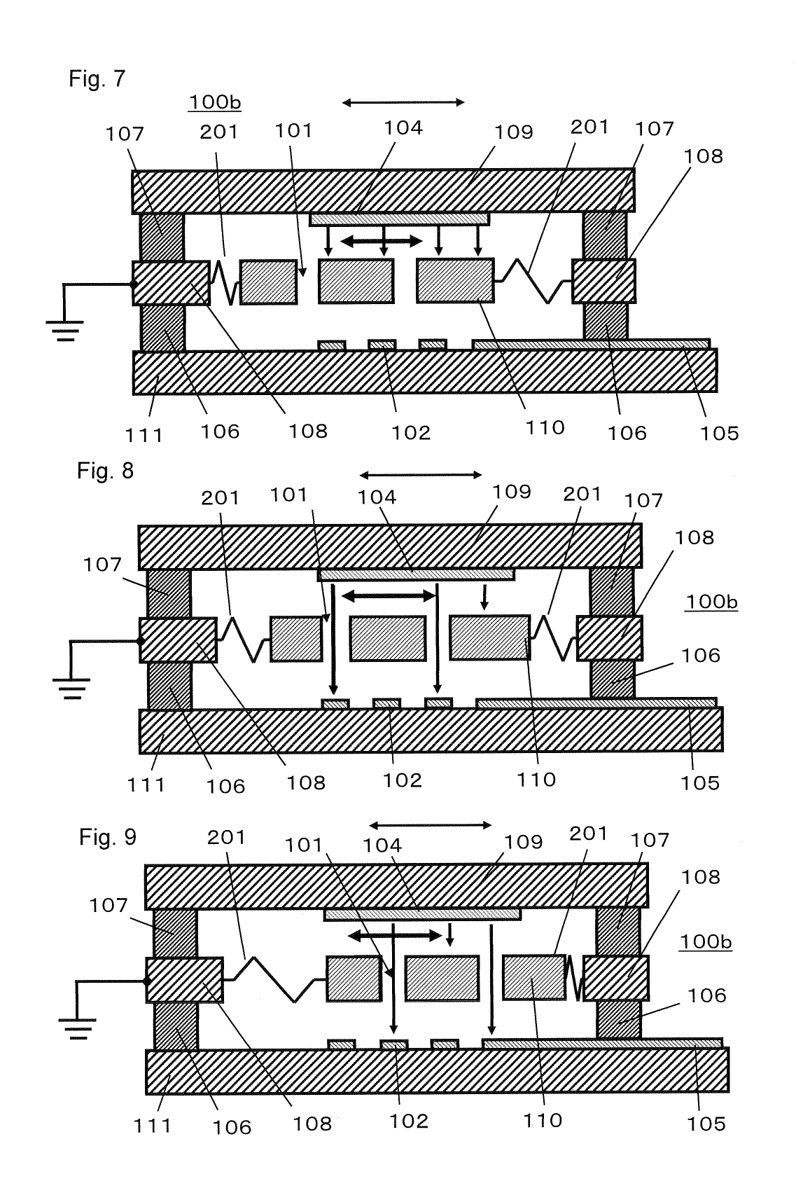

FIG. 7 to FIG. 9 are cross-sectional views illustrating a configuration of a micro-electro-mechanical generator 100b according to a second modified example of the first embodiment. The micro-electro-mechanical generator 100b according to the second modified example is different from the micro-electro-mechanical generator 100 according to the first embodiment illustrated in FIG. 1 and FIG. 2 and the micro-electro-mechanical generator 100a according to the first modified example of the first embodiment illustrated in FIG. 5 and FIG. 6 in that there are the first electrodes 102 patterned into four electrodes, in that the movable substrate 110 is provided with two slits 101, and in that the movable substrate 110 is caused to vibrate over two of the first electrodes 102.

According to the micro-electro-mechanical generator 100b of the second modified example, while the pattern of the first electrodes 102 and the pattern of the slits 101 are not identical, a cycle of the first electrodes 102 and a cycle of the slits 101 are in a relation of integral multiple with each other, and the first electrodes 102 and the slits 101 are patterned in the cycles that can be synchronized with each other.

Thus, according to the micro-electro-mechanical generator 100b of the second modified example, the overlapping area between the electret 104 and the first electrodes 102 through the slits 101 may change between maximum and minimum twice in a single vibration, when the movable substrate 110 is caused to vibrate over the two first electrodes 102.

Method of Manufacturing Micro-Electro-Mechanical Generator

Next, a method of manufacturing the micro-electro-mechanical generator 100 illustrated in FIG. 1 will be described.

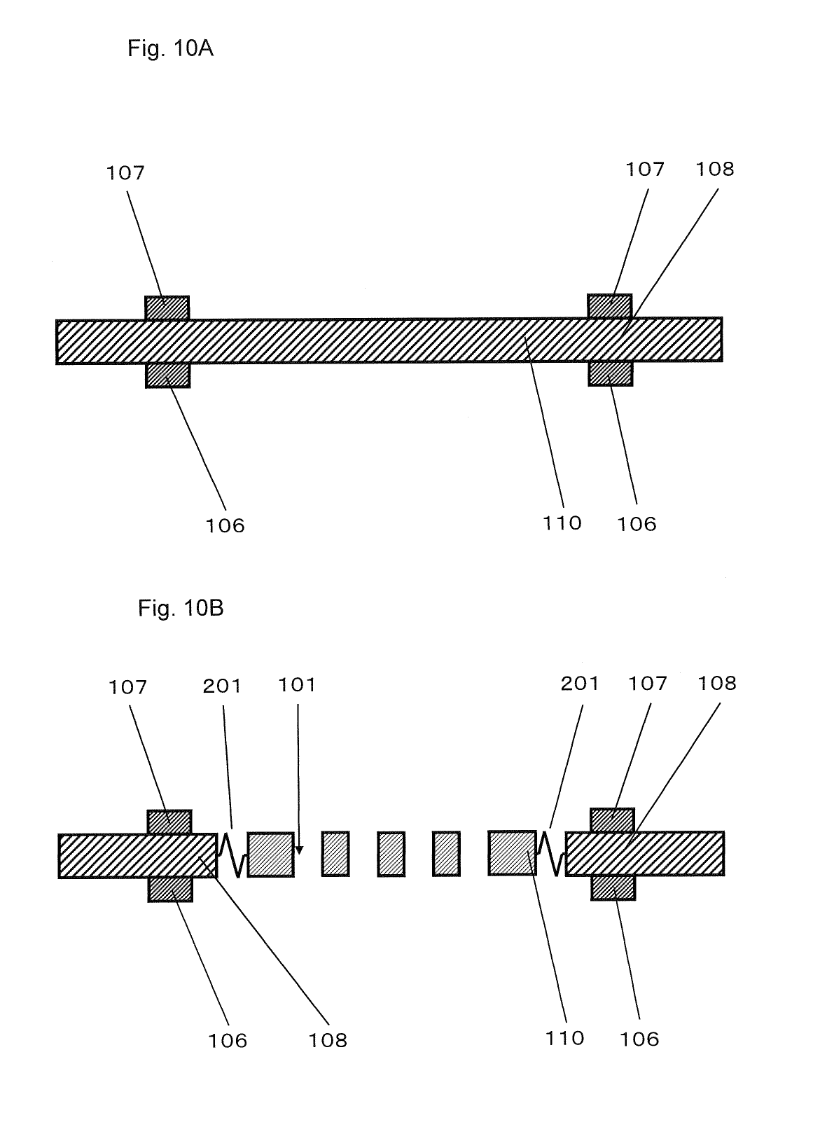

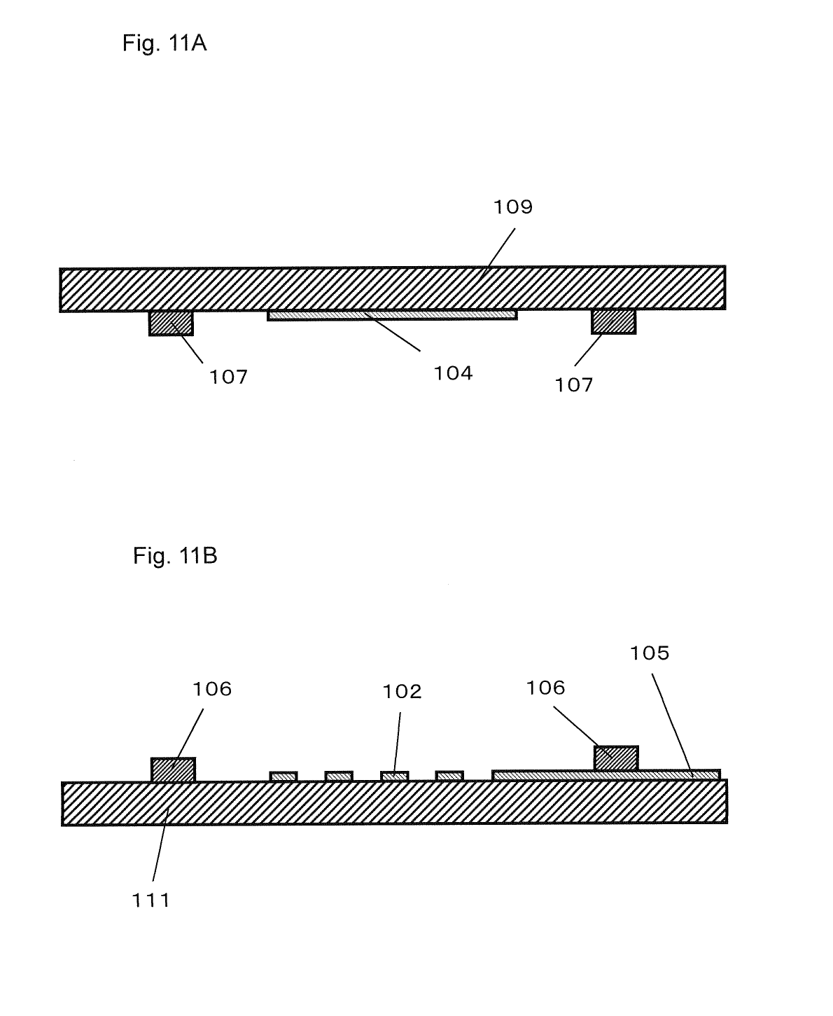

FIGS. 10A and 10B, FIGS. 11A and 11B, FIGS. 12A and 12B, and FIG. 13 are cross-sectional views each illustrating the method of manufacturing the micro-electro-mechanical generator 100 according to the first embodiment. A method of processing a single substrate to form the movable substrate 110, the spring 201, and the static structure 108 (that is, the intermediate substrate 108 to which the movable substrate 110 is connected via the elastic structures 201) is described with reference to FIGS. 10A and 10B.

FIG. 10A is the sectional view illustrating a state in which the joint portions 106 and 107 are provided on a substrate. As the substrate, a silicon substrate may be used, for example. The substrate is required to have a certain weight in order to be able to vibrate as the movable substrate 110 after the processing. Accordingly, it is desirable that a thickness of the substrate be within a range from 100 μm to 1 mm. Here, the description is given taking a case in which a 700 μm thick silicon substrate is used.

Next, a seed layer for plating processing (not depicted) is formed, a form is formed by photolithography using resist, and the upper joint portions 107 are formed by plating processing. Then, the resist is removed. Examples of a material for the seed layer include titanium, copper, and a film stack of these materials, and copper may be used as a material for the joint portions.

Subsequently, the lower joint portions 106 are formed on a surface opposite to the surface on which the upper joint portions 107 are formed. A seed layer for plating processing (not depicted) is formed, a form is formed by photolithography using resist, and the lower joint portions 106 are formed by plating processing. Then, the resist is removed.

Next, as illustrated in FIG. 10B, the substrate is processed by mask formation and deep reactive ion etching (DRIE) into a member including the spring 201, the movable substrate 110 having the slits 101 as openings, and the static structure 108.

Processing of the upper substrate 109 is described with reference to FIG. 11A. FIG. 11A is the sectional view illustrating a state in which the electret 104 and the upper joint portions 107 are provided on the surface of the upper substrate 109. After forming an interlayer dielectric film such as a silicon dioxide film on the surface of the upper substrate 109, the electret 104 is formed. The electret 104 is formed by having an electret material be deposited, and patterning the electret material by a process such as photolithography or etching. Examples of the electret material include an inorganic material such as a silicon dioxide film, a silicon nitride film, or a multi-layer film of these materials, and an organic material.

Next, a seed layer for plating processing (not depicted) is deposited, a form is formed by photolithography using resist, and the upper joint portions 107 are formed by plating processing. Then, the resist is removed. Examples of a material for the seed layer include titanium, copper, and a film stack of these materials, and copper, tin, or a film stack of these materials may be used as a material for the joint portions.

Processing of the lower substrate 111 is described with reference to FIG. 11B. FIG. 11B is the sectional view illustrating a state in which the first electrodes 102, the pad 105, and the lower joint portions 106 are provided on the surface of the lower substrate 111. After forming an interlayer dielectric film such as a silicon dioxide film on the surface of the lower substrate 111, the first electrodes 102 and the pad 105 are formed. The first electrodes 102 and the pad 105 are formed by having a material for electrodes and a pad to be formed into the first electrodes 102 and the pad 105 be deposited on the surface of the lower substrate 111 (first surface), and patterning the material by the process such as photolithography or etching. The material for electrodes and a pad is a metallic material such as aluminum.

Next, a seed layer for plating processing (not depicted) is deposited, a form is formed by photolithography using resist, and the lower joint portions 106 are formed by plating processing. Then, the resist is removed. Examples of a material for the seed layer include titanium, copper, and a film stack of these materials, and copper, tin, or a film stack of these materials may be used as a material for the joint portions.

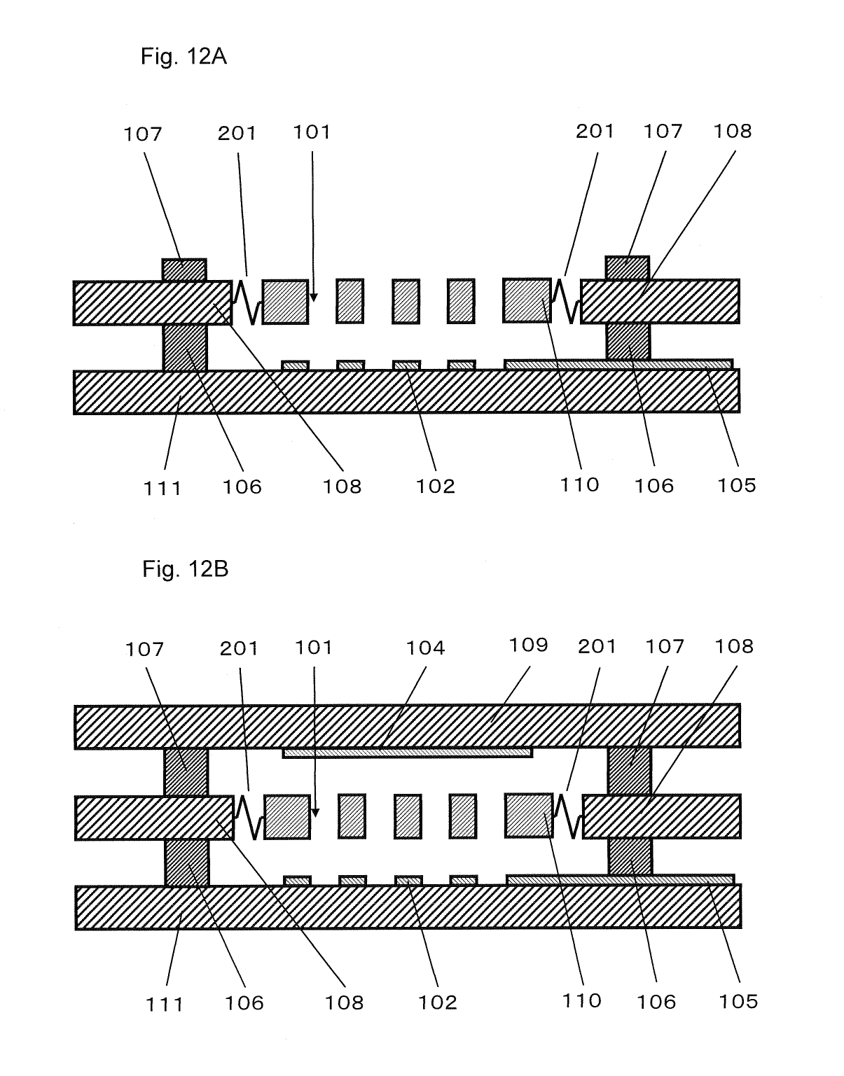

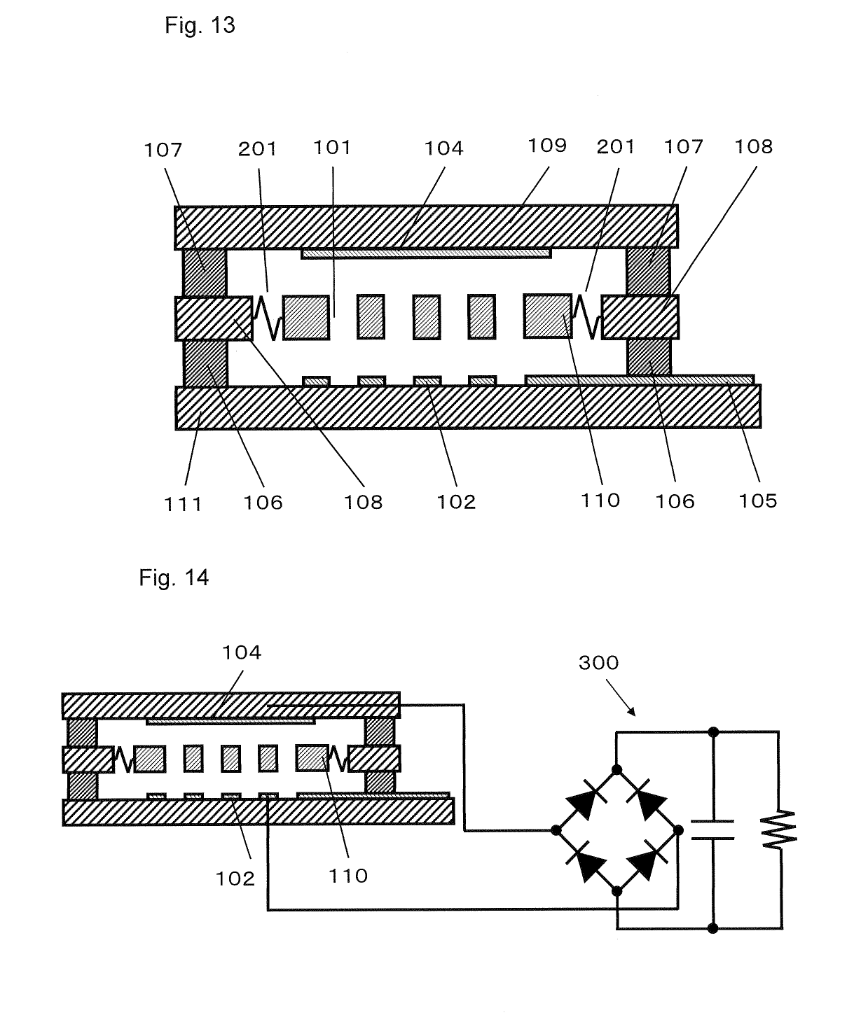

Assembly processing of the movable substrate 110, the spring 201, and the static structure 108 that have been formed by processing a single substrate, the upper substrate 109, and the lower substrate 111 is described with reference to FIG. 12 and FIG. 13. Referring to FIG. 12A, the lower substrate 111 and the static structure 108 are joined by joining the lower joint portions 106 on the respective substrates with each other. Next, referring to FIG. 12B, the upper substrate 109 and the static structure 108 are joined by joining the upper joint portions 107 on the respective substrates with each other after an electric-charged step of the first electret 104 formed on the surface of the upper substrate 109.

FIG. 13 shows a step of processing the upper substrate 109, the static structure 108, and the lower substrate 111 by a grinder or by deep reactive ion etching to expose the pad 105 and singulate the power generator.

It is possible to achieve the micro-electro-mechanical generator 100 according to the first embodiment by the manufacturing method including the above steps.

Circuit Configuration of Micro-Electro-Mechanical Generator

FIG. 14 is a circuit diagram illustrating a circuit configured using the micro-electro-mechanical generator 100 according to the first embodiment.

FIG. 14 shows a circuit configuration of a conversion circuit 300 configured to output electric power to an external load through the first electrodes 102. The conversion circuit 300 converts alternating current outputted by repeating power feed and discharge in the first electrodes 102 into direct current. The conversion circuit 300 is connected between the first electrodes 102 and the upper substrate 109 on which the electret 104 is provided. The conversion circuit 300 may include, for example, a bridge rectifier circuit configured by four diodes, a smoothing circuit configured by a capacitor, and a load resistor. The conversion circuit 300 is connected to the external load by wire-bonding or the like.

### Second Embodiment

Configuration of Micro-Electro-Mechanical Generator

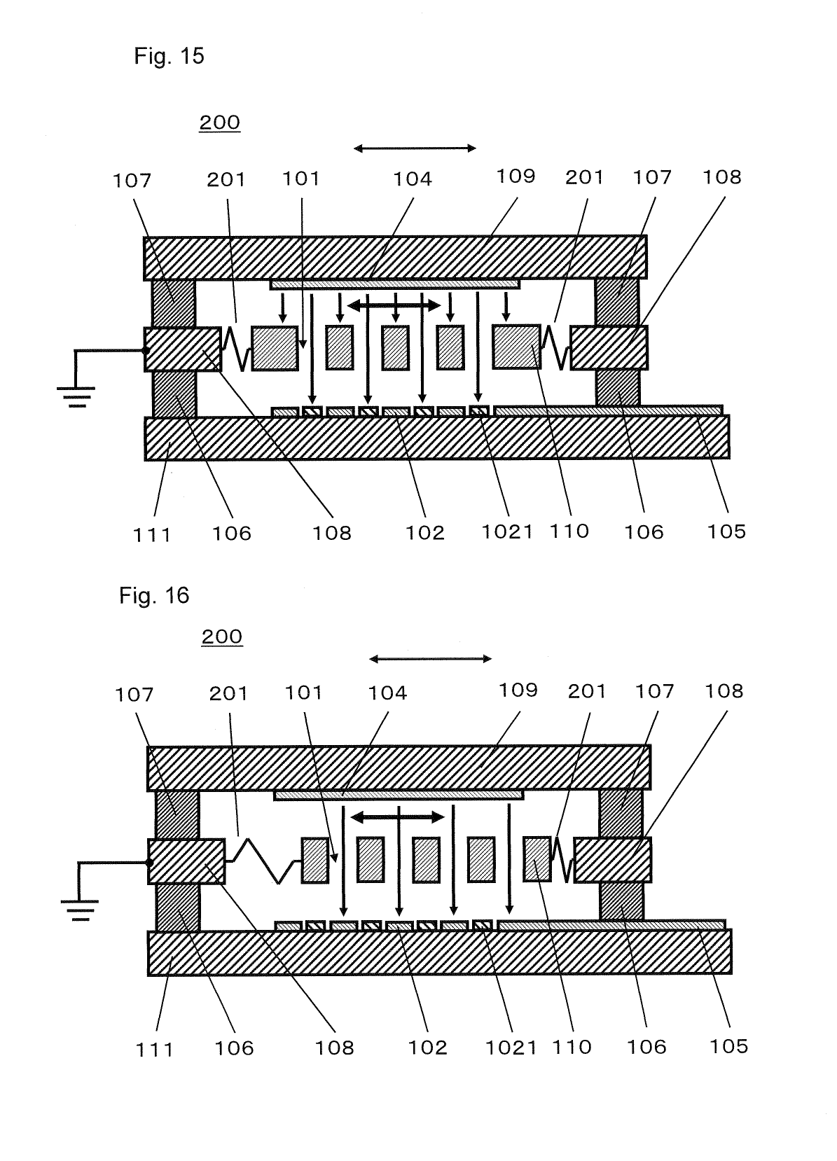

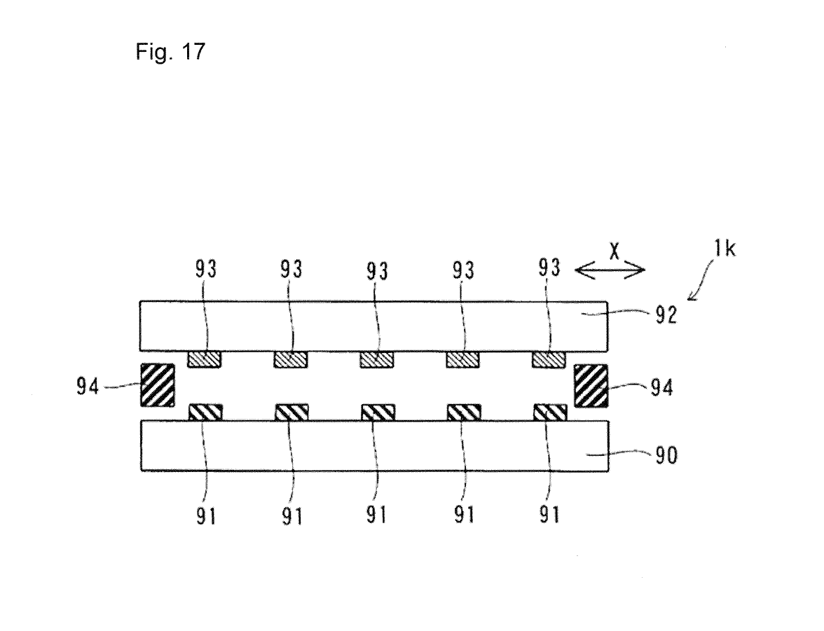

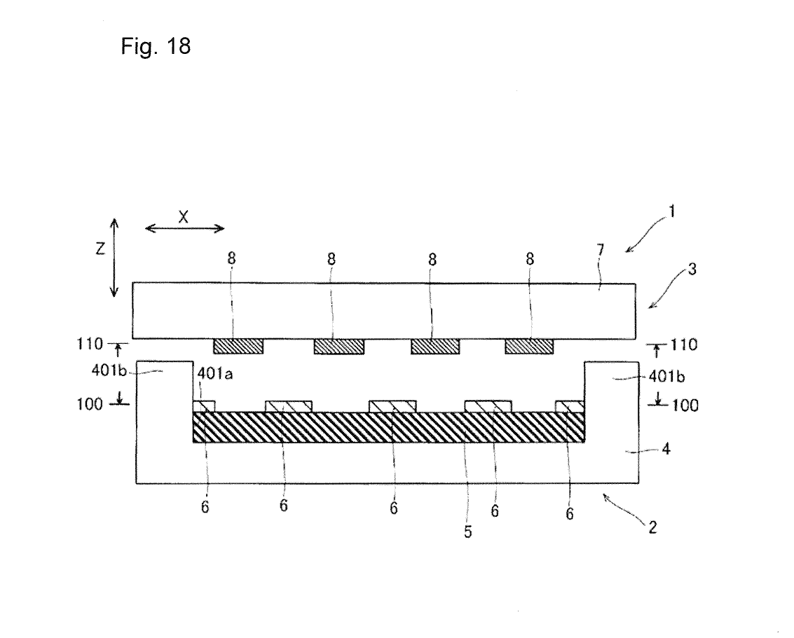

FIG. 15 and FIG. 16 are cross-sectional views illustrating a configuration of a micro-electro-mechanical generator 200 according to the second embodiment.

The micro-electro-mechanical generator 200 according to the second embodiment is different from the micro-electro-mechanical generator 100 according to the first embodiment in that a plurality of second electrodes 1021 are provided respectively between the plurality of first electrodes 102 on the surface of the lower substrate 111 (first substrate surface). Therefore, in the embodiment illustrated in FIG. 15, the second electrodes 1021 and the slits 101 are aligned with each other when viewed perpendicularly to the first substrate surface. On the other hand, in a state as illustrated in FIG. 16, the movable substrate 110 moves, and the second electrodes 1021 and the slits 101 are arranged so as to be misaligned (shifted) when viewed perpendicularly to the first substrate surface.

According to such a configuration, in the embodiment illustrated in FIG. 15, the electric field generated from the electret 104 can be pulled into the second electrodes 1021, to prevent an unnecessary electric field from reaching the first electrodes 102, and to sufficiently release the electric charge excited in the first electrodes 102.

Therefore, according to the micro-electro-mechanical generator 200, in addition to the effect described according to the first embodiment (improvement of reliability), an effect of increasing an amount of power generation can be provided.

In either of the first embodiment and the second embodiment, the description is given assuming that the lower substrate 111 is the first substrate and the upper substrate 109 is the second substrate. It should be appreciated that the micro-electro-mechanical generators 100 and 200 respectively according to the first embodiment and the second embodiment described above may be used upside down. Further, the pad 105 may be provided on the upper substrate 109. Alternatively, as a different embodiment, the lower substrate 111 may be the second substrate and the upper substrate 109 may be the first substrate. As used herein, the terms “first” and “second” are used to distinguish the two substrates, and not to indicate a vertical relationship between the substrates.

In the first embodiment and the second embodiment, the movable substrate 110 is supported by the static structure 108 by being connected to the static structure 108 via the elastic structures 201. The support of the movable substrate 110 to the static structure 108 may be achieved, for example, by a magnetic force or an electrostatic force as long as the movable substrate 110 reciprocatory moves along a predetermined direction. Further, when the movable substrate 110 is supported by an electrostatic force, for example, the first substrate 111 and the second substrate 109 may serve as the static structure 108. In this case, for example, electrets may be provided on the surfaces of the first substrate 111 and the movable substrate 110 that face each other, and electrets may be provided on the surfaces of the second substrate 109 and the movable substrate 110 that face each other. Further, the electrets may be electric-charged as having the same electric charge, such that the movable substrate 110 may be supported based on an electrostatic force (repulsive force) between the electrets.

Further, according to the first embodiment and the second embodiment, the movement direction of the movable substrate 110 is set to be parallel to one side of the first substrate and the second substrate when these substrates are assumed to be rectangular or square as illustrated in FIG. 4. However, in the micro-electro-mechanical generator, the above description of the embodiments shall not preclude a direction of the movement of the movable substrate different from the above direction, instead of or in addition to the above direction.

The micro-electro-mechanical generator according to the present invention is able to achieve an increase of an amount of power generation and an improvement of reliability, and therefore may be effective as a power source for various electrical devices.

1. A micro-electro-mechanical generator, comprising:
a first substrate configured to hold an electric charge on a surface of the substrate, and to have an electret film continuously provided on the surface;
a second substrate having a collecting electrode provided on a surface facing the electret film; and
a movable substrate having conductive property, disposed between the first substrate and the second substrate, and supported movably along a predetermined direction with respect to the first substrate and the second substrate,
wherein the movable substrate includes an opening penetrating through the movable substrate from a side of the first substrate to a side of the second substrate and allowing an electric field emitted from the electret film to pass through, and
the movement of the movable substrate either causes or stops to cause the electric field to be emitted to the collecting electrode through the opening, and power is generated by the electric charge being excited in and discharged from the collecting electrode depending on whether or not the electric field is caused to be emitted.

2. The micro-electro-mechanical generator according to claim 1, wherein the movable substrate is supported vibratably along the predetermined direction.

3. The micro-electro-mechanical generator according to claim 1, wherein the movable substrate is supported movably with respect to the first substrate and the second substrate so as to change an overlapping area between the electret film and the collecting electrode through the opening in the movable substrate in a process of the movement.

4. The micro-electro-mechanical generator according to claim 1, wherein the opening in the movable substrate is patterned into a plurality of the openings.

5. The micro-electro-mechanical generator according to claim 1, wherein the collecting electrode of the second substrate is patterned into a plurality of the collecting electrodes.

6. The micro-electro-mechanical generator according to claim 1, wherein the collecting electrode is patterned into a plurality of the collecting electrodes having a first cycle along the predetermined direction,
the opening is patterned into a plurality of the openings having a second cycle along the predetermined direction, and
the first cycle and the second cycle are in a relation of integral multiple with each other, such that the collecting electrode and the opening are patterned in cycles synchronizable with each other.

7. The micro-electro-mechanical generator according to claim 1, wherein the collecting electrode is patterned into a plurality of the collecting electrodes having a cyclic pattern along the predetermined direction, and
the opening is patterned into a plurality of the openings having a cyclic pattern identical to the cyclic pattern of the collecting electrodes along the predetermined direction.

8. The micro-electro-mechanical generator according to claim 1, wherein the movable substrate is grounded.

9. The micro-electro-mechanical generator according to claim 1, further comprising:
a guard electrode that is grounded,
wherein the collecting electrode is patterned into a plurality of the collecting electrodes, and
the guard electrode is provided between each pair of the collecting electrodes.

10. An electrical device, comprising:
the micro-electro-mechanical generator according to claim 1 as a power source.
